(19) United States
(12) Patent Application Publication
(10) Pub. No.: US 2026/0246625 A1
(43) Pub. Date: Aug. 20, 2026

(54) QUANTUM KEY DISTRIBUTION SYSTEM, TRANSMITTER, RECEIVER AND METHOD

(71) Applicant: Telefonaktiebolaget LM Ericsson (publ), Stockholm (SE)

(72) Inventors: Peter TRÓCSÁNYI, Budapest (HU); Benedek KOVÁCS, Budapest (HU); Márton CZERMANN, Dunakeszi (HU); Áron Dénes SZABÓ, Budapest (HU)

(73) Assignee: Telefonaktiebolaget LM Ericsson (publ), Stockholm (SE)

(21) Appl. No.: 19/162,435

(22) PCT Filed: Mar. 7, 2023
(86) PCT No.: PCT/SE2023/050209

§ 371 Date: Sep. 5, 2025

(51) Int. Cl. H04L 9/08; H04B 10/548

(52) U.S. Cl. CPC H04L 9/0855; H04B 10/548

(57) ABSTRACT

An auto-compensating QKD system. The system includes a QKD transmitter and a QKD receiver. The QKD receiver is configured to send an initial optical pulse train to the QKD transmitter and to receive a reference optical pulse train followed by a signal optical pulse train from the QKD transmitter. The QKD transmitter is configured to receive the initial optical pulse train from the QKD receiver and to send the reference optical pulse train and the signal optical pulse train to the QKD receiver.

### TECHNICAL FIELD

The invention relates to an auto-compensating QKD system, a QKD transmitter for an auto-compensating QKD system, a QKD receiver for an auto-compensating QKD system and a method of operating an auto-compensating QKD system.

### BACKGROUND

Quantum communication systems exploit the possibility of transmitting information encoded in quantum states, prepared in such a way that an eavesdropper in between two communicating partners unavoidably introduces a detectable disturbance. In optical communications, the quantum information is encoded over a physical property of a photon, as for example polarization state or phase.

Quantum Key Distribution, QKD, provides a solution to the problem of key distribution in symmetric encryption systems. In theory, quantum encryption should be applied to the whole message that is to be transmitted, using one-time pad encryption. However, this would unacceptably compromise capacity and latency of the communication channel, since feasible QKD systems can only work up to a few Mbit/s and require processing time for the sender and receiver to agree the final key, free of errors. In practice, QKD is only used to produce and distribute the key, not to transmit message data. The key is then used with a classical encryption algorithm to encrypt and decrypt a message, transmitted over a classical high capacity communication channel.

In QKD based on the BB84 protocol, as described for example by A. Ruiz-Alba et al “Practical Quantum Key Distribution based on the BB84 protocol”, Waves, 2011, pages 4-14, the sender, Alice, generates a random bit, i.e. a “0” or a “1”, and encodes it in one of two different bases over a properly chosen physical property of the photon. One of the bases is then used to encode the “0” bits and the other is used to encode the “1” bits.

Since the receiver, Bob, does not know Alice's basis selection, he measures the basis of the incoming photons by randomly choosing one of the possible two basis. If he uses the same basis used by Alice, he will measure deterministically the correct bit value. Conversely, if he chooses the wrong basis, the result of his measurement will be a random projection on the possible values of the encoded basis, which gives the correct result only with a 50% probability. After a long sequence of photons has been exchanged, Alice and Bob compare the basis they have respectively employed for encoding and measuring, communicating via a “classical” channel. They keep only the random bits generated and detected with matched basis, which are said to constitute the “sifted keys”. In an ideal system without noise, imperfections, and disturbances, the sifted keys are identical, and can be used as a private key.

In the so-called “Plug & play” auto compensating QKD system reported by D Stucki et al, “Quantum key distribution over 67 km with a plug&play system”, New J. Phys. Issue 4 2002, pages 41.1-41.8, the key is encoded in the phase difference between two pulses travelling from Bob to Alice and back. In this system, as illustrated in the PRIOR ART FIG. 1, optical pulses generated at Bob are split by a 50/50 beam splitter, BS, travel through a short arm and a long arm, including a phase modulator, PM, and a 50 ns delay line, DL, of an interferometer to a polarization beam splitter, PBS. All fibres and optical elements at Bob are polarization maintaining and the linear polarization is rotated by 90° in the short arm, so both pulses exit from the same output of the PBS. Pairs of pulses are thus output from Bob and transmitted to Alice. At Alice, the pulses are reflected by a Faraday mirror (undergoing 90° polarization rotation), attenuated at a variable attenuator, ATT, and are transmitted back to Bob orthogonally polarized. To implement the BB84 protocol in this system the phase modulator, PM, at Alice applies a phase shift chosen from 0 and π or π/2 or 3 π/2 on the second pulse and Bob chooses the measurement basis by applying a phase shift of 0 or π/2 on the first pulse using its PM. Since the pulses transmitted from Alice to Bob now have the orthogonal polarizations, each takes the other path through the interferometer at Bob and arrive at the BS at the same time, where they interfere; since each pulse has travelled the same path from Bob to Alice and back, the system is auto-compensated. The resultant pulses output from the BS are detected at the single photon detectors, SPAD1 and SPAD2, depending on the measurement basis selected by Bob.

At Alice, the PM should phase modulate the second pulse of the pulse-pairs. The time separation between the first and second pulse of a pulse-pair is of the order of 10 s of nanoseconds, hence the timing of the drive signal to the PM needs to be very accurate. At Bob, the PM should phase modulate the pulses returning from Alice. The time separation between pulse-pairs is approximately 200 ns, hence the round trip time of the pulses should be known to better than this accuracy. The SPADs at Bob are gated so that they are set to an active state when the returning pulses arrive, which also requires precise knowledge of the round-trip time of the pulses.

WO 2022/135704 A1 discloses an auto-compensating QKD system in which photon detection statistics during an initial phase enable a time grid of pulse arrival at the QKD receiver to be determined. During a subsequent key distribution phase, detection anticipation enables quantum key signal detections at single photon avalanche detectors, SPADs, to be separated from detections at the SPADs induced by noise based on their time difference from the time grid estimated during the initial phase.

### SUMMARY

It is an object to provide an improved auto-compensating QKD system. It is a further object to provide an improved QKD transmitter for an auto-compensating QKD system. It is a further object to provide an improved QKD receiver for an auto-compensating QKD system. It is a further object to provide an improved method of operating an auto-compensating QKD system.

An aspect provides a quantum key distribution, QKD, receiver, for an auto-compensating QKD system. The QKD receiver comprises an optical source configured to generate an initial optical pulse train, an optical input/output port, an optical tap, a first optical detector, a variable optical attenuator, VOA, an optical phase modulator, a second optical detector, a third optical detector and processing circuitry. The optical input/output port is for outputting the initial optical pulse train and for receiving a reference optical pulse train followed by a signal optical pulse train. The optical tap is configured to tap off a portion of the power of the reference optical pulse train to form trigger optical pulses. The first optical detector is configured to output a trigger signal in response to detecting at least one of the trigger optical pulses. The VOA is provided after the optical tap. The VOA is configurable to block or forward optical pulse trains. The VOA has a first condition and a second condition. In the first condition the VOA is configured to block the reference optical pulse train and in the second condition the VOA is configured to forward optical pulses from the signal optical pulse train. The optical phase modulator is configured to phase modulate part of the signal optical pulse train. The second optical detector and the third optical detector are configured to detect final optical pulses resulting from the signal optical pulse train undergoing forwarding by the VOA and phase modulation by the optical phase modulator. The processing circuitry is configured to receive the trigger signal and to generate at least one control signal in response. The at least one control signal is configured to cause the VOA to be configured in the open condition. The at least one control signal is additionally configured to enable the second optical detector and the third optical detector to detect final optical pulses.

The QKD receiver enables continuous time alignment of the operation of the QKD receiver with a QKD transmitter during quantum key distribution within an auto-compensating QKD system by separately processing a reference optical pulse train and a signal optical pulse train. The QKD receiver thus mitigates uncertainty in detection timing caused by thermo-mechanical fluctuations in a propagation line between the QKD transmitter and the QKD receiver. This advantageously enables adaptive operation of the QKD receiver without requiring key transmission to be stopped while time alignment is re-established, resulting in high availability of the QKD system.

In an embodiment, the optical source comprises a laser and an optical interferometer. The laser is configured to generate a seed optical pulse train of seed optical pulses. The optical interferometer comprises a beam splitter and a polarization beam splitter connected by a short arm and a long arm. The long arm includes a delay line. The optical phase modulator is provided in one of the long arm or the short arm. The beam splitter is configured to power split the seed pulses into the short arm and the long arm. The VOA is provided between the polarization beam splitter and the optical tap and in the second condition the VOA is configured to forward the signal optical pulse train to the polarization beam splitter. The optical phase modulator is configured to phase modulate part of the signal optical pulse train in said one arm. The short arm is configured to give seed pulses a first polarization and the long arm is configured to give seed pulses a second, orthogonal polarization, to form the initial optical pulse train comprising pairs of orthogonally polarized optical pulses. The VOA advantageously blocks the reference optical pulse train and forwards the signal optical pulse train to the optical interferometer, for formation of final optical pulses for detection by the second optical detector and the third optical detector.

In an embodiment, the optical source comprises a laser and an optical interferometer. The laser is configured to generate a seed optical pulse train of seed optical pulses. The optical interferometer comprises a beam splitter and a polarization beam splitter connected by a short arm and a long arm. The long arm includes a delay line. The optical phase modulator is provided in one of the long arm or the short arm. The beam splitter is configured to power split the seed pulses into the short arm and the long arm. The optical phase modulator is configured to phase modulate part of the signal optical pulse train in said one arm. The VOA is provided in front of the second optical detector. In the second condition, the VOA is configured to forward final optical pulses to the second optical detector. The QKD receiver additionally comprises a second VOA. The second VOA is provided in front of the third optical detector. The second VOA is configurable to block or forward optical pulse trains. The second VOA has a first condition and a second condition. In the first condition, the second VOA is configured to block the reference optical pulse train. In the second condition, the second VOA is configured to forward final optical pulses to the third optical detector. The VOA and the second VOA advantageously block the reference optical pulse train and forward final optical pulses, formed as a result of transmission of the signal optical pulse train through the optical interferometer, to the second optical detector and the third optical detector.

In an embodiment, the QKD receiver further comprises a polarization controller between the input/output port and the polarization beam splitter, a first optical tap before the VOA and a second optical tap before the second VOA. The polarization controller is operable to control the polarization of the reference optical pulse train such that at least the first optical pulse of the reference optical pulse train is equally power split into first reference optical pulse and a second reference optical pulse by the beam splitter of the interferometer. The beam splitter is configured to route the first reference optical pulse towards the first optical tap and to route the second reference optical pulse towards the second optical tap.

In an embodiment, the at least one control signal is configured to cause the VOA to be configured in the second condition. The at least one control signal is additionally configured to enable the second optical detector and the third optical detector to detect final optical pulses a predetermined time after receipt of the trigger signal. This advantageously ensures that the second optical detector and the third optical detector are only enabled at a time when final optical pulses are expected to arrive, which may mitigate detection errors due to background noise.

In an embodiment, the predetermined time is a time delay between the reference optical pulse train and the signal optical pulse train. This advantageously ensures that the second optical detector and the third optical detector are only enabled at a time when the signal optical pulse train is expected to arrive, which may mitigate detection errors due to background noise. The QKD receiver is able to use a predefined delay to enable precisely timed gated functionality for the second and third optical detectors. This advantageously results in the second and third detectors only detecting the final optical pulses, and noise reduction is significantly enhanced as a result.

Corresponding embodiments and advantages also apply to the auto-compensating quantum key distribution system and the method described below.

An aspect provides a QKD transmitter for an auto-compensating QKD system. The QKD transmitter comprises an input/output port configured to receive an initial optical pulse train, a first optical beam splitter, a photodetector, an optical storage line, a second optical beam splitter, optical routing apparatus, an optical phase modulator, a polarization rotation mirror and processing circuitry. The first optical beam splitter is configured to power split the initial optical pulse train to form a first optical pulse train and a second optical pulse train. The photodetector is configured to detect optical pulses of the first optical pulse train and to output corresponding detection signals. The optical storage line is configured to receive the second optical pulse train. The second optical beam splitter is configured to receive the second optical pulse train output from the storage line. The second optical beam splitter is configured to power split the second optical pulse train to form a reference optical pulse train and a third optical pulse train. The optical routing apparatus is configured to route the reference optical pulse train back to the input/output port. The optical phase modulator is configured to phase modulate optical pulses of the third optical pulse train. The polarization rotation mirror is arranged to reflect the third optical pulse train back through the optical phase modulator and storage line, to form a signal optical pulse train. The processing circuitry is configured to cause the optical phase modulator to phase modulate optical pulses of the third optical pulse train in response to receiving a detection signal. The storage line is configured to introduce a time delay, t, between the reference optical pulse train and the signal optical pulse train. The input/output port is further configured to output the reference optical pulse train followed by the signal optical pulse train.

The QKD transmitter enables continuous time alignment of the operation of the QKD transmitter with a QKD receiver during quantum key distribution within an auto-compensating QKD system by forming a reference optical pulse train and a signal optical pulse train. Formation of a reference optical pulse train and a signal optical pulse train mitigates uncertainty in detection timing at the QKD receiver caused by thermo-mechanical fluctuations in a propagation line between the QKD transmitter and the QKD receiver. This advantageously enables adaptive operation of the QKD receiver without requiring key transmission to be stopped while time alignment is re-established, resulting in high availability of the QKD system.

In an embodiment, the optical storage line is thermally stabilized. This advantageously enables the time delay introduced between the reference optical pulse train and the signal optical pulse train to remain constant and known.

Corresponding embodiments and advantages also apply to the auto-compensating quantum key distribution system and the method described below.

An aspect provides an auto-compensating quantum key distribution, QKD, system comprising a QKD transmitter and a QKD receiver.

The QKD receiver comprises an optical source configured to generate an initial optical pulse train, an optical input/output port, an optical tap, a first optical detector, a variable optical attenuator, VOA, an optical phase modulator, a second optical detector, a third optical detector and processing circuitry. The optical input/output port is for outputting the initial optical pulse train and for receiving a reference optical pulse train followed by a signal optical pulse train. The optical tap is configured to tap off a portion of the power of the reference optical pulse train to form trigger optical pulses. The first optical detector is configured to output a trigger signal in response to detecting at least one of the trigger optical pulses. The VOA is provided after the optical tap. The VOA is configurable to block or forward optical pulse trains. The VOA has a first condition and a second condition. In the first condition the VOA is configured to block the reference optical pulse train and in the second condition the VOA is configured to forward the signal optical pulse train. The optical phase modulator is configured to phase modulate part of the signal optical pulse train. The second optical detector and the third optical detector are configured to detect final optical pulses resulting from the signal optical pulse train undergoing forwarding by the VOA and phase modulation by the optical phase modulator. The processing circuitry is configured to receive the trigger signal and to generate at least one control signal in response. The at least one control signal is configured to cause the VOA to be configured in the open condition. The at least one control signal is additionally configured to enable the second optical detector and the third optical detector to detect final optical pulses.

The QKD transmitter comprises an input/output port configured to receive the initial optical pulse train, a first optical beam splitter, a photodetector, an optical storage line, a second optical beam splitter, optical routing apparatus, an optical phase modulator, a polarization rotation mirror and processing circuitry. The first optical beam splitter is configured to power split the initial optical pulse train to form a first optical pulse train and a second optical pulse train. The photodetector is configured to detect optical pulses of the first optical pulse train and to output corresponding detection signals. The optical storage line is configured to receive the second optical pulse train. The second optical beam splitter is configured to receive the second optical pulse train output from the storage line. The second optical beam splitter is configured to power split the second optical pulse train to form a reference optical pulse train and a third optical pulse train. The optical routing apparatus is configured to route the reference optical pulse train back to the input/output port. The optical phase modulator is configured to phase modulate optical pulses of the third optical pulse train. The polarization rotation mirror is arranged to reflect the third optical pulse train back through the optical phase modulator and storage line, to form a signal optical pulse train. The processing circuitry is configured to generate a control signal in response to receiving a detection signal. The control signal is configured to cause the optical phase modulator to phase modulate optical pulses of the third optical pulse train. The storage line is configured to introduce a time delay, t, between the reference optical pulse train and the signal optical pulse train. The input/output port is further configured to output the reference optical pulse train followed by the signal optical pulse train.

The QKD receiver is configured to send the initial optical pulse train to the QKD transmitter and to receive the reference optical pulse train followed by a signal optical pulse train from the QKD transmitter. The QKD transmitter is configured to receive the initial optical pulse train from the QKD receiver and to send the reference optical pulse train and the signal optical pulse train to the QKD receiver.

The auto-compensating QKD system enables continuous time alignment of the operation of the QKD receiver with the QKD transmitter during quantum key distribution by using the same initial optical pulse train to form both a reference optical pulse train and a signal optical pulse train of qubits, for key distribution. The QKD system thus mitigates uncertainty in detection timing caused by thermo-mechanical fluctuations in a propagation line between the QKD transmitter and the QKD receiver. This advantageously enables adaptive operation without requiring key generation to be stopped while time alignment is re-established, resulting in high availability of the QKD system. The QKD system may therefore be used in network scenarios which require continuous key generation.

In an embodiment, the initial optical pulse train has an initial optical pulse power. The first beam splitter at the QKD transmitter is configured with a first splitting ratio for forming the second optical pulse train. The second beam splitter at the QKD transmitter is configured with a second splitting ratio to form the third optical pulse train. The first splitting ratio and the second splitting ratio in combination cause the optical pulses of the signal optical pulse train to comprise less than one photon per pulse on average. This may ensure that qubits are transmitted using a signal optical pulse train comprising single photon pulses, meaning that the qubits cannot be intercepted by an eavesdropper.

In an embodiment, at the QKD receiver, the predetermined time after receipt of the trigger signal is at least equal to the time delay, t, introduced by the storage line at the QKD transmitter. This advantageously ensures that the second optical detector and the third optical detector are only enabled at a time when the signal optical pulse train is expected to arrive, which may mitigate detection errors due to background noise. The QKD receiver is able to use a predefined delay to enable precisely timed gated functionality for the second and third optical detectors. This advantageously results in the second and third detectors only detecting the final optical pulses, and noise reduction is significantly enhanced as a result.

Corresponding embodiments and advantages also apply to the method described below.

An aspect provides a method of operating an auto-compensating quantum key distribution, QKD, system comprising a QKD receiver and a QKD transmitter. The method comprises the following steps. Sending an initial optical pulse train from the QKD receiver to the QKD transmitter. At the QKD transmitter, splitting the initial optical pulse train to form a reference optical pulse train and a second optical pulse train. At the QKD transmitter, phase modulating and time delaying the second optical pulse train relative to the reference optical pulse train, to form a signal optical pulse train. Sending the reference optical pulse train and the signal optical pulse train from the QKD transmitter to the QKD receiver. At the QKD receiver, tapping off a portion of the power of the reference optical pulse train to form trigger optical pulses. At the QKD receiver, blocking the reference optical pulse train after formation of the trigger optical pulses and subsequently forwarding the signal optical pulse train to be detected. In response to detecting trigger optical pulses, enabling phase modulation of part of the signal optical pulse train and enabling detection of final optical pulses resulting from phase modulation and forwarding of the signal optical pulse train.

Embodiments of the invention will now be described, by way of example only, with reference to the accompanying drawings.

### BRIEF DESCRIPTION OF THE DRAWINGS

FIG. 1 is a schematic diagram of a prior “Plug & play” auto compensating QKD system;

FIGS. 2 and 3 are schematic diagrams of embodiments of QKD receivers for an auto-compensating QKD system;

FIG. 4 is a schematic diagram of an embodiment of a QKD transmitter for an auto-compensating QKD system;

FIGS. 5 and 6 are schematic diagrams of embodiments of an auto-compensating QKD system; and

FIG. 7 is a flowchart illustrating an embodiments of method steps.

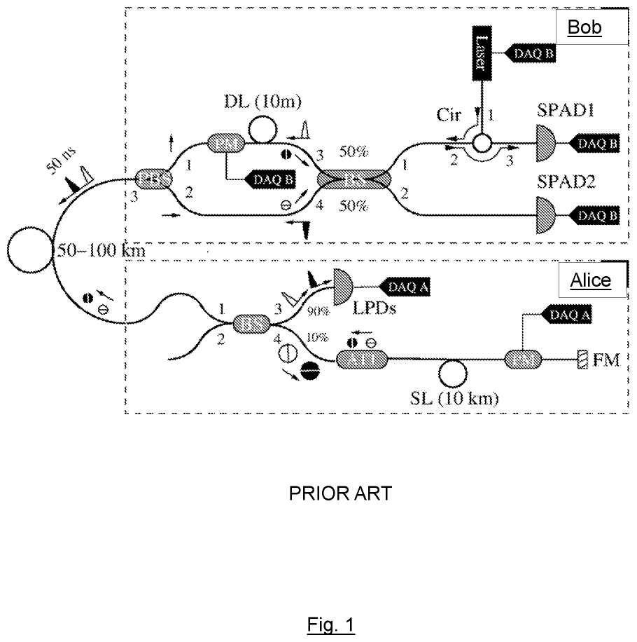

### DETAILED DESCRIPTION

The same reference numbers are used for corresponding features in different embodiments.

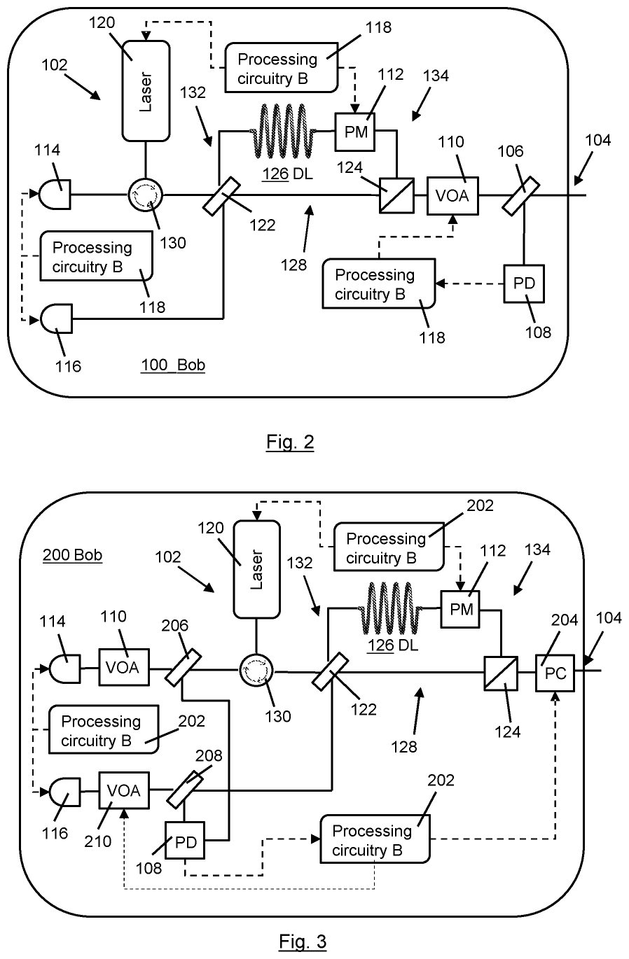

Referring to FIG. 2, an embodiment provides a quantum key distribution, QKD, receiver 100 for an auto-compensating QKD system. The QKD receiver comprises an optical source 102, an optical input/output port 104, an optical tap 106, a first optical detector 108, a variable optical attenuator, VOA, 110, an optical phase modulator 112, a second optical detector 114, a third optical detector 116 and processing circuitry 118.

The optical source 102 is configured to generate an initial optical pulse train. An optical pulse train is a sequence of optical pulses having a defined structure, such as a defined number of pulses, time separation between pulses, pulses arranged in pairs, time separation between pulse pairs, etc.

The optical source 102 comprises a laser 120, an optical circulator 130 and an interferometer 132. The interferometer comprises a 50:50 optical beam splitter, BS, 122, and a polarization beam splitter, PBS, 124, connected by a short arm 128 and a long arm 134 including a delay line 126. The phase modulator 112 is provided in one of the interferometer arms; in this example the phase modulator is provided in the long arm but it may alternatively be provided n the short arm. The laser generates a seed optical pulse train which is routed to the BS via the optical circulator 130 (in the case of an optical fibre based implementation). The seed optical pulses are power split at the BS with the respective split optical pulses output into the short arm 128 and the long arm 134 of the interferometer; the optical pulses travelling through the long arm are delayed by the delay line, so they are delayed relative to those travelling through the short arm. The short arm is configured to give seed pulses a first polarization and the long arm is configured to give seed pulses a second, orthogonal polarization. For example, the short arm comprises polarization maintaining fibre of a first polarization and the long arm comprises polarization maintaining fibre of a second, orthogonal polarization incident on the PBS. The PBS 124 combines pulses from the short arm with corresponding delayed, orthogonally polarized optical pulses from the long arm, so that an initial optical pulse train of pairs of orthogonally polarized optical pulses is formed at the output of the PBS 124; the pulses in each pair are separated in time by the time delay added by the delay line 126.

The optical input/output port 104 is for outputting the initial optical pulse train and for receiving a reference optical pulse train followed by a signal optical pulse train. Like the initial optical pulse train, the signal optical pulse train comprises pairs of orthogonally polarized optical pulses, but the pulses of the pulse pairs of the signal optical pulse train will have orthogonal polarizations to the pulses of the pulse pairs of the initial optical pulse train.

The pulses of received signal optical pulse trains are very weak (less than 1 photon on average). The second optical detector and the third optical detector therefore need to be gated, i.e. only enabled to detect, when signal pulses are expected to be received, to minimize noise error. The second and third optical detectors are closed during the round trip time of sending the initial optical pulse train to a QKD transmitter and receiving the signal optical pulse train, to avoid the optical detectors being in a blind state (unable to detect pulses) when the signal optical pulse train arrives. This is achieved using the reference optical pulse train to generate a control signal for the second and third optical detectors, as follows.

The optical tap 106 is configured to tap off a portion of the power of the reference optical pulse train to form trigger optical pulses. The first optical detector 108 is configured to output a trigger signal in response to detecting at least one of the trigger optical pulses.

The VOA 110 is provided between the PBS 124 and the optical tap 106. The VOA is configurable to block or forward optical pulse trains. The VOA has a first condition in which it is configured to block the reference optical pulse train and a second condition in which its is configured to forward the signal optical pulse train to the PBS. The VOA 110 additionally has a third condition in which it is configured to forward the initial optical pulse train to the output 104.

The optical phase modulator 112 is configured to phase modulate part of the signal optical pulse train in the arm in which it is provided, in this example the long arm. The first and second optical pulses of each pulse pair of the signal optical pulse train received at the PBS 124, from the VOA 110, are routed into the long and short arms of the interferometer according to their polarization. Since the optical pulses of the signal optical pulse train have orthogonal polarizations to the optical pulses of the initial optical pulse train, the optical pulses of the signal pulse train will be routed into the other interferometer arm to the arm that the corresponding initial optical pulse travelled through. Both optical pulses of each optical pulse pair will therefore have passed through the delay line 126 (during formation of the initial optical pulse train or on their way back within the signal optical pulse train), as a result of which they arrive together back at the BS 122, where they interfere depending on their respective phases and a final optical pulse is formed (for each optical pulse pair), which is routed to either the second optical detector 114 or the third optical detector 116, depending on the relative phases of the optical pulses from which it is formed.

The second optical detector 114 and the third optical detector 116 are configured to detect final optical pulses resulting from the signal optical pulse train undergoing forwarding by the VOA 110 and phase modulation by the optical phase modulator 112 during transmission back through the interferometer 132.

The second optical detector and the third optical detector 114, 116 are single-photon detectors, such as single photon avalanche diode, SPAD, photon counters or photomultipliers, having a single-photon detection efficiency of less than 1. Blocking transmission of the reference optical pulse train by the VOA protects these sensitive optical detectors from the optical pulses of the reference optical pulse train, which will typically be stronger than the optical pulses of the signal optical pulse train, to ensure that the second and third optical detectors are not in a blind state when the signal optical pulse train arrives.

The processing circuitry 118 is configured to receive the trigger signal and to generate at least one control signal in response. The at least one control signal is configured to cause the VOA to be configured in the open condition. The at least one control signal is additionally configured to enable the second optical detector and the third optical detector to detect final optical pulses. The QKD receiver 100 is thus operative to ensure that only signal optical pulses are forwarded by the VOA 110 and that the second and third optical detectors 114, 116 are gated to detect the final pulses resulting from the forwarded signal optical pulses.

In an embodiment, the laser 120 is configured to generate optical pulses at a 5 MHz pulse rate, i.e. a pulse train having a pulse-pulse time separation of around 200 ns. The seed optical pulse train contains 480 optical pulses, therefore the initial optical pulse train (and thus each of the first and second optical pulse trains) contains 480 optical pulse pairs. The delay line 126 has a length of around 10 m, to introduce a delay of around 50 ns, thus the optical pulses with the pulse pairs are separated by around 50 ns and the pulse pairs are separated by around 200 ns.

In an embodiment, the at least one control signal is configured to enable the second optical detector 114 and the third optical detector 116 to detect final optical pulses a predetermined time after receipt of the trigger signal.

In an embodiment, the predetermined time is a time delay between the reference optical pulse train and the signal optical pulse train.

Referring to FIG. 3, an embodiment provides a quantum key distribution, QKD, receiver 200 for an auto-compensating QKD system. The QKD receiver 200 comprises an optical source 102, an optical input/output port 104, a first optical tap 206, a second optical tap 208, a polarization controller, PC, 204, a first optical detector 108, a first VOA, 110, a second VOA 210, an optical phase modulator 112, a second optical detector 114, a third optical detector 116 and processing circuitry 202.

The optical source 102 is configured to generate an initial optical pulse train of pairs of orthogonally polarized optical pulses. The optical source 102 comprises a laser 120, an optical circulator 130 and an interferometer 132, as described above with reference to FIG. 2.

The optical input/output port 104 is for outputting the initial optical pulse train and for receiving a reference optical pulse train followed by a signal optical pulse train.

The pulses of received signal optical pulse trains are very weak (less than 1 photon on average). The second optical detector and the third optical detector therefore need to be gated, i.e. only enabled to detect, when signal pulses are expected to be received, to minimize noise error. The second and third optical detectors are closed during the round trip time of sending the initial optical pulse train to a QKD transmitter and receiving the signal optical pulse train, to avoid the optical detectors being in a blind state (unable to detect pulses) when the signal optical pulse train arrives. This is achieved using the reference optical pulse train to generate a control signal for the second and third optical detectors, as follows.

The PC 204 is provided between the input/output port 104 and the PBS 124. The PC is operable to forward optical pulse trains without performing polarization control, or perform polarization control on optical pulse trains. The PC has a first condition in which it is configured to perform polarization control on the reference optical pulse train such that at least the first optical pulse of the reference optical pulse train is equally power split into a first reference optical pulse and a second reference optical pulse by the beam splitter of the interferometer. The beam splitter is configured to route the first reference optical pulse towards the first optical tap 206 and to route the second reference optical pulse train towards second optical tap 208. The PC has a second condition in which it is configured to forward the signal optical pulse train without performing polarization control.

The first optical tap 206 is configured to tap off a portion of the power of the first reference optical pulse train to form first trigger optical pulses, which are routed to the first optical detector 108. The second optical tap 208 is configured to tap off a portion of the power of the second reference optical pulse train to form second trigger optical pulses, which are also routed to the first optical detector 108.

The first optical detector 108 is configured to output a trigger signal in response to detecting at least one of the first trigger optical pulses and the second trigger optical pulses.

The optical phase modulator 112 is configured to phase modulate part of the signal optical pulse train in the long arm. The first and second optical pulses of each pulse pair received at the PBS 124 are routed into the long and short arms of the interferometer respectively according to their polarization, i.e. into the other interferometer arm to the arm which they propagated in during forming of the initial optical pulse train, so that they arrive together back at the BS 122, where they interfere depending on their respective phases and a final optical pulse (for each pulse pair) is formed. The final optical pulse is routed towards either the first optical tap 206 or the second optical tap 208, depending on its phase.

The first VOA 110 is provided between the first optical tap 206 and the second optical detector 114. The second VOA 210 is provided between the second optical tap 208 and the third optical detector 116. Each VOA 110, 210 is configurable to block or forward optical pulses. Each VOA has a first condition in which it is configured to block the reference optical pulse train and a second condition in which its is configured to forward final optical pulses to the respective optical detector 114, 116.

The second optical detector 114 and the third optical detector 116 are configured to detect final optical pulses resulting from the signal optical pulse train undergoing phase modulation by the optical phase modulator 112 during transmission back through the interferometer 132 and forwarding by the first VOA 110 or second VOA 210 respectively.

The second optical detector and the third optical detector 114, 116 are single-photon avalanche diode, SPAD, photon counters having a single-photon detection efficiency of less than 1. Blocking transmission of the reference optical pulse train by the VOAs 110, 210 protects these sensitive optical detectors from the optical pulses of the reference optical pulse train, which will typically be stronger than the optical pulses of the signal optical pulse train, to ensure that the second and third optical detectors are not in a blind state when the signal optical pulse train arrives.

The processing circuitry 202 is configured to receive the trigger signal and to generate at least one control signal in response. The at least one control signal is configured to cause the PC 204 to be configured in the second condition. The at least one control signal is additionally configured to cause the first VOA 110 and the second VOA 210 to be configured in the open condition. The at least one control signal is additionally configured to enable the second optical detector and the third optical detector to detect final optical pulses.

The QKD receiver 200 is thus operative to ensure that only signal optical pulses are forwarded by the VOAs 110, 210 and that the second and third optical detectors 114, 116 are gated to detect the final pulses resulting from the forwarded signal optical pulses.

In an embodiment, the laser 120 is configured to generate optical pulses at a 5 MHz pulse rate, i.e. a pulse train having a pulse-pulse time separation of around 200 ns. The seed optical pulse train contains 480 optical pulses, therefore the initial optical pulse train (and thus each of the first and second optical pulse trains) contains 480 optical pulse pairs. The delay line 126 has a length of around 10 m, to introduce a delay of around 50 ns, thus the optical pulses with the pulse pairs are separated by around 50 ns and the pulse pairs are separated by around 200 ns.

In an embodiment, the at least one control signal is configured to enable the second optical detector 114 and the third optical detector 116 to detect final optical pulses a predetermined time after receipt of the trigger signal.

In an embodiment, the predetermined time is a time delay between the reference optical pulse train and the signal optical pulse train.

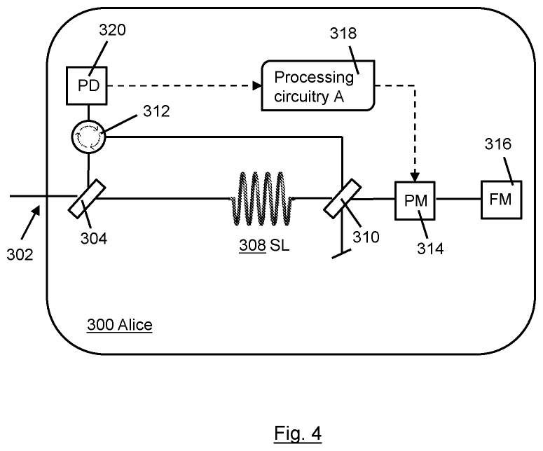

Referring to FIG. 4, an embodiment provides a QKD transmitter 300 for an auto-compensating QKD system. The QKD transmitter 300 comprises an input/output port 302, a first optical beam splitter 304, a photodetector 320, an optical storage line 308, a second optical beam splitter 310, optical routing apparatus 312, an optical phase modulator PM 314, a polarization rotation mirror 316 and processing circuitry 318.

The input/output port 302 is configured to receive an initial optical pulse train. The first optical beam splitter 304 is configured to power split the initial optical pulse train to form a first optical pulse train and a second optical pulse train. The photodetector 320 is configured to detect optical pulses of the first optical pulse train and to output corresponding detection signals to the processing circuitry. The optical storage line 308 is configured to receive the second optical pulse train and to apply a time delay, t, to the second optical pulse train.

The second optical beam splitter 310 is configured to receive the second optical pulse train output from the storage line. The second optical beam splitter 310 is configured to power split the second optical pulse train to form a reference optical pulse train and a third optical pulse train. The second optical beam splitter is configured to route the reference optical pulse train towards the optical routing apparatus 312, which is configured to route the reference optical pulse train back to the input/output port 302.

The second optical beam splitter is configured to route the third optical pulse train to the optical phase modulator 314, which is configured to phase modulate optical pulses of the third optical pulse train.

The polarization rotation mirror 316, for example a Faraday mirror, FM, is arranged to reflect the third optical pulse train back towards the optical phase modulator, so that the third optical pulse train passes back through the optical phase modulator and the storage line, to form a signal optical pulse train. The input/output port 302 is further configured to output the reference optical pulse train followed by the signal optical pulse train.

The processing circuitry 318 is configured to cause the optical phase modulator 314 to phase modulate optical pulses of the third optical pulse train in response to receiving a detection signal.

In an embodiment, the initial optical pulse train is pairs of orthogonally polarized optical pulses. The control signal generated by the processing circuitry 318 is configured to cause the PM 314 to phase modulate one optical pulse of each pair of orthogonally polarized optical pulses of the third optical pulse train. By only phase modulating one optical pulse in a pulse pair the QKD transmitter prepares a raw key qubit using the phase difference between the optical pulses of pulse pairs.

In an embodiment, the QKD transmitter 300 further comprises a variable optical attenuator, VOA, 306 provided between the BS 304 and the PM 314, for example between the BS and the storage line 308. The VOA is configurable to apply an attenuation to the third optical pulse train. This may enable the signal optical pulse train to be formed of single photon pulses.

In an embodiment, the second optical beam splitter 310 is configured to split in the range 50% to 90% of the optical power of the second optical pulse train into the reference optical pulse train. A linear photodetector may therefore be used at the QKD receiver for detecting the reference optical pulse train.

In an embodiment, the optical storage line 308 is thermally stabilized.

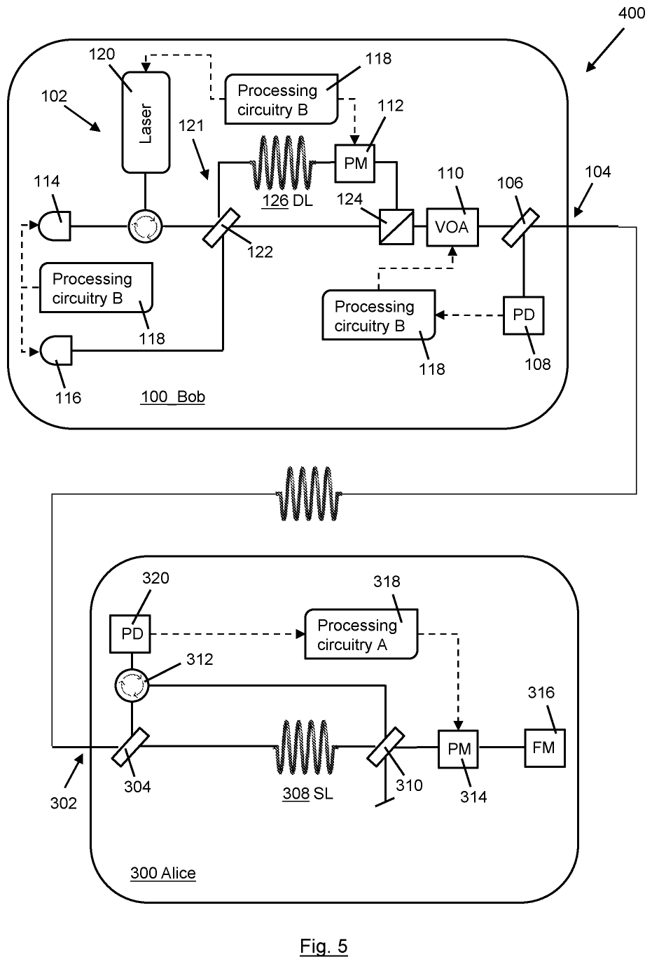

Referring to FIG. 5, an embodiment provides an auto-compensating quantum key distribution, QKD, system 400 comprising a QKD transmitter 300 and a QKD receiver 100, as described above.

The QKD receiver 100 is configured to send the initial optical pulse train to the QKD transmitter 300. The QKD receiver 100 is configured to receive the reference optical pulse train followed by a signal optical pulse train from the QKD transmitter.

The QKD transmitter 300 is configured to receive the initial optical pulse train from the QKD receiver and to send the reference optical pulse train and the signal optical pulse train to the QKD receiver.

In an embodiment, the initial optical pulse train has an initial optical pulse power. The first beam splitter 304 at the QKD transmitter is configured with a first splitting ratio for forming the second optical pulse train. The second beam splitter 310 at the QKD transmitter is configured with a second splitting ratio to form the third optical pulse train. The first splitting ratio and the second splitting ratio in combination cause optical pulses of the signal optical pulse train to comprise less than one photon per pulse on average.

In an embodiment, at the QKD receiver, the predetermined time after receipt of the trigger signal is at least equal to the time delay, t, introduced by the storage line at the QKD transmitter.

In an embodiment, the predetermined time is time delay between the reference optical pulse train and the signal optical pulse train. This is predominantly produced by the storage line 308 at the QKD transmitter, which the signal optical pulse train transits twice, while the reference optical pulse train transits it only once. Strictly speaking however, the time delay is the delay caused by the difference in the optical paths lengths travelled by the reference optical pulse train from the second optical splitter 310 to the first optical splitter 304 and by the third optical pulse train/signal optical pulse train from the second optical splitter 310 back to the first optical splitter 304. The reference optical pulse train path length is from the second optical splitter to the first optical splitter 304, via the optical circulator 312 and connecting optical fibres/waveguides. The third optical pulse train/signal optical pulse train path length is from the second optical splitter 310, through the PM 314 to the FM 316, and back from the FM through the PM, the second optical splitter, the storage line and connecting optical fibres/waveguides to the first optical splitter.

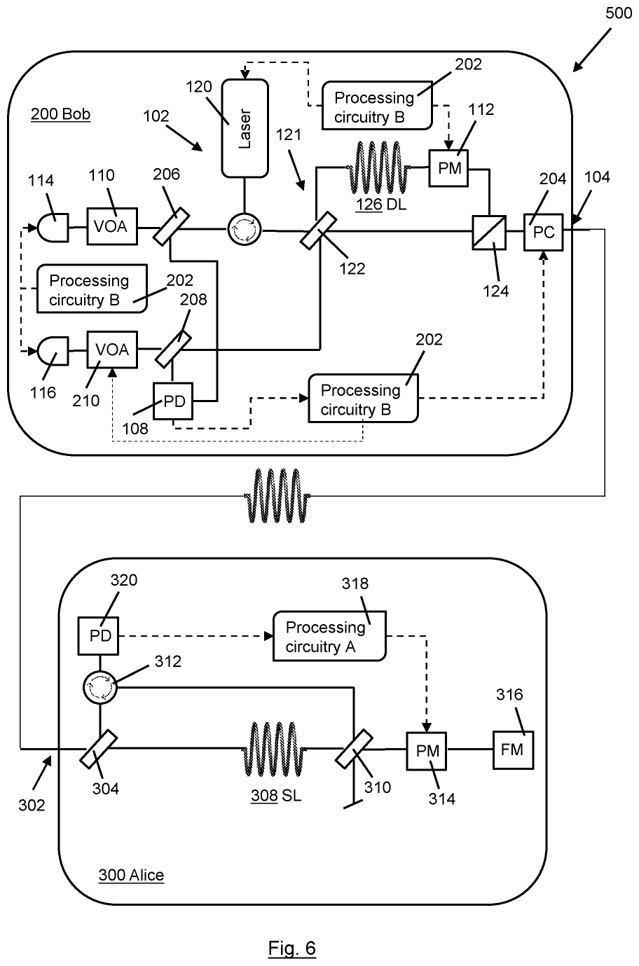

Referring to FIG. 6, an embodiment provides an auto-compensating QKD system 500 comprising a QKD transmitter 300 and a QKD receiver 200, as described above.

The QKD receiver 200 is configured to send the initial optical pulse train to the QKD transmitter 300. The QKD receiver 100 is configured to receive the reference optical pulse train followed by a signal optical pulse train from the QKD transmitter.

The QKD transmitter 300 is configured to receive the initial optical pulse train from the QKD receiver and to send the reference optical pulse train and the signal optical pulse train to the QKD receiver.

Referring to FIG. 5, a further embodiment provides an auto-compensating QKD system 500 for a QKD scenario in the optical domain that requires below-one photon number per pulse on average. The envelopes of the pulses represent the qubits. The system 500 enables temporal synchronization of the two communication parties, QKD transmitter 300 and QKD receiver 100.

Continuous synchronization of the pulse generation and detection at the QKD receiver with the phase modulation at the QKD transmitter is achieved by using the majority of the power of the initial optical pulse train transmitted by the QKD receiver to form a timing reference (the reference optical pulse train), while the remaining power of the initial optical pulse train is used to form a signal optical pulse train for key distribution. Accordingly, continuous synchronization is achieved through the detection of the reference optical pulse train at the QKD receiver avoiding the need for more complex optimization of QKD quality on a regular basis, as required by the prior art.

The pulse-pairs of the initial optical pulse train generated at the QKD receiver 100 traverse an optical fibre connecting the QKD transmitter and the QKD receiver. Then they pass through a 90:10 beam splitter, BS, 304 at the QKD transmitter. Phase modulation by the optical phase modulator, PM, 314 at the QKD transmitter is triggered by a detection signal of a linear photo diode, PD, 320, indicating the signal from the 90% output of the BS 304. For the timing of the phase modulation at the QKD transmitter, the same method as described in WO 20221/35704 A1 is used. The optical pulses leaving the 10% output of the BS 304 traverse the storage line, SL, 310 and arrive at a 90:10 BS 310 that splits the original signal into a reference optical pulse train and a third optical pulse train, to be formed into a signal optical pulse train carrying qubits for key distribution.

The reference optical pulse train is directed back to the QKD receiver unit via a circulator 312 without any manipulation. As the reference optical pulse train arrives back at the QKD receiver, 1% of the optical power of the reference optical pulse train is tapped off using a 1:99 beam splitter 106 and sent to a linear detector, PD, right before the polarization beam splitter, PBS, 124 could affect their route. This way we do not need any polarization control on the reference optical pulse train.

Although the reference optical pulse train is attenuated at the 1:99 BS by 20 dB, the optical power of the tapped reference optical pulses is high enough to be detected with a linear photo detector, PD 108. The signal optical pulse train will suffer the least attenuation this way, maximizing the SNR (Signal-to-Noise Ratio) for their detection at single photon avalanche detectors, SPADs, 114, 116. As the 1:99 beam splitter lets the majority of the reference optical pulses travel on towards the SPADs, a VOA 110 is provided to suppress the remaining 99% of the power of the reference optical pulse train to avoid damaging the SPADs.

When the tapped reference optical pulses are detected at the PD 108, detection electrical signals are output. Using the first detection signal as a first trigger signal, the processing circuitry sets a precise timing for gating the SPADs to detect. For this, we need to measure the optical length of the QKD transmitter only once, at the installation process. Starting a timer from the first trigger signal from the PD 108, we can generate a control signal to enable the SPADs to achieve a gated detection only when the signal optical pulse train arrives. Since we can generate and detect the reference optical pulse train by this method for each signal optical pulse train sent from the QKD transmitter to the QKD receiver, any time fluctuations in the propagation line between the QKD transmitter and the QKD receiver are automatically compensated for. This way we can solve the aforementioned issue of realigning detection gating with a solution resistant to environmental fluctuations.

Regarding the signal optical pulse train, this is processed to form qubits in the same manner as described in WO 2022/135704 A1.

The general purpose of QKD systems is to support the security of networked communication systems and services where and whenever sensitive data is transferred. Some communication scenarios impose the requirement of continuous key generation, thus QKD systems face difficulties raised by harsh environmental conditions causing fluctuations of propagation time of light pulses every time a pulse train is transmitted through the system. The QKD systems described above make real-time fluctuation compensation feasible without the need of starting new initial phases repeatedly, enabling continuous key generation.

Detection anticipation has a large influence on reducing the noise in the system which is also a fundamental problem of detection methods in current QKD devices. In the QKD systems described above, the QKD receiver uses a predefined delay to enable precisely timed gated functionality for the SPADs. Detecting only the signal optical pulse train in this way, noise reduction is being enhanced significantly as a result.

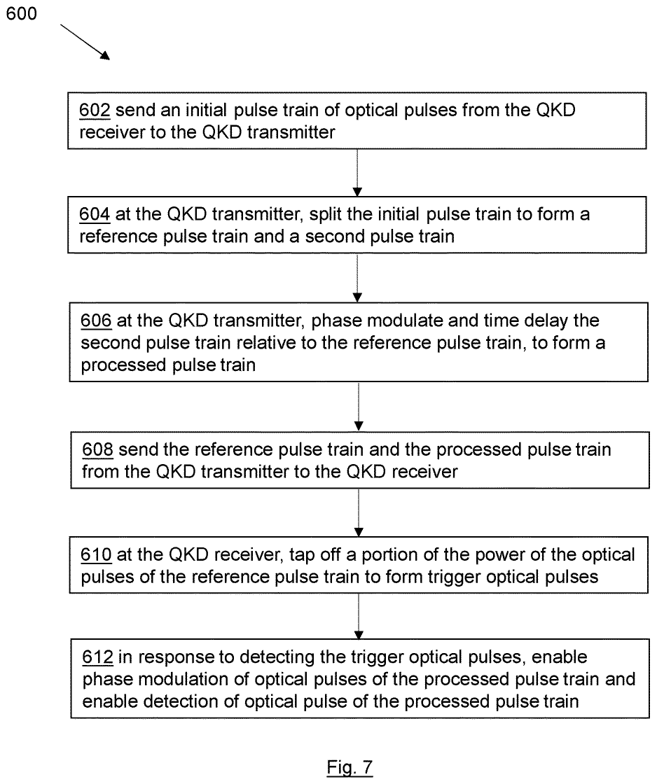

Referring to FIG. 7, an embodiment provides a method 600 of operating an auto-compensating QKD system comprising a QKD receiver and a QKD transmitter.

The method comprises sending 602 an initial optical pulse train from the QKD receiver to the QKD transmitter. At the QKD transmitter, the initial optical pulse train is split 604 to form a reference optical pulse train and a second optical pulse train. At the QKD transmitter, the second optical pulse train is phase modulated and time delayed 606 to form a signal optical pulse train; the second optical pulse train is time delayed relative to the reference optical pulse train. The reference optical pulse train and the signal optical pulse train are then sent 608 from the QKD transmitter to the QKD receiver. At the QKD receiver, a portion of the power of the reference optical pulse train is tapped off 610 to form trigger optical pulses. At the QKD receiver, the reference optical pulse train is blocked after formation of the trigger optical pulses, and the signal optical pulse train is subsequently forwarded to be detected. In response to detecting trigger optical pulses 612, phase modulation of part of the signal optical pulse train is enabled at the QKD receiver, and detection of final optical pulses resulting from phase modulation and forwarding of the signal optical pulse train is also enabled at the QKD receiver.

1. A quantum key distribution, (QKD) receiver, for an auto-compensating QKD system, the QKD receiver comprising:
an optical source configured to generate an initial optical pulse train;
an optical input/output port for outputting the initial optical pulse train and for receiving a reference optical pulse train followed by a signal optical pulse train;
an optical tap, configured to tap off a portion of the power of the reference optical pulse train to form trigger optical pulses;
a first optical detector configured to output a trigger signal in response to detecting at least one of the trigger optical pulses;
a variable optical attenuator, VOA, provided after the optical tap, the VOA being configurable to block or forward optical pulse trains, wherein the VOA has a first condition in which it is configured to block the reference optical pulse train and a second condition in which its is configured to forward optical pulses from the signal optical pulse train;
an optical phase modulator configured to phase modulate part of the signal optical pulse train;
a second optical detector and a third optical detector, configured to detect final optical pulses resulting from the signal optical pulse train undergoing forwarding by the VOA and phase modulation by the optical phase modulator; and
processing circuitry, configured to receive the trigger signal and to generate at least one control signal in response, the at least one control signal is configured to cause the VOA to be configured in the open condition and the at least one control signal is configured to enable the second optical detector and the third optical detector to detect final optical pulses.

2. The QKD receiver of claim 1, wherein the optical source comprises:
a laser configured to generate a seed optical pulse train of seed optical pulses; and
an optical interferometer comprising:
a beam splitter and a polarization beam splitter connected by a short arm and a long arm, the long arm including a delay line and the optical phase modulator, wherein
the beam splitter is configured to power split the seed pulses into the short arm and the long arm,
the VOA is provided between the polarization beam splitter and the optical tap and in the second condition the VOA is configured to forward the signal optical pulse train to the polarization beam splitter,
the optical phase modulator is configured to phase modulate part of the signal optical pulse train in the long arm,
the short arm is configured to give seed pulses a first polarization, and
the long arm is configured to give seed pulses a second, orthogonal polarization, to form the initial optical pulse train comprising pairs of orthogonally polarized optical pulses.

3. The QKD receiver of claim 1, wherein the optical source comprises:
a laser configured to generate a seed optical pulse train of seed optical pulses; and
an optical interferometer comprising a beam splitter and a polarization beam splitter connected by a short arm and a long arm, the long arm including a delay line and the optical phase modulator, wherein
the beam splitter is configured to power split the seed pulses into the short arm and the long arm,
the optical phase modulator is configured to phase modulate part of the signal optical pulse train in the long arm and the optical phase modulator is additionally configured to phase modulate the seed pulses in the long arm, to form the initial optical pulse train comprising pairs of orthogonally polarized optical pulses,
the VOA is provided in front of the second optical detector and in the second condition the VOA is configured to forward final optical pulses to the second optical detector, and
the QKD receiver additionally comprises a second VOA provided in front of the third optical detector, the second VOA being configurable to block or forward optical pulse trains, and
the second VOA has a first condition in which it is configured to block the reference optical pulse train and a second condition in which it is configured to forward final optical pulses to the third optical detector.

4. The QKD receiver of claim 3, further comprising:
a polarization controller between the input/output port and the polarization beam splitter;
a first optical tap before the VOA; and
a second optical tap before the second VOA, wherein
the polarization controller is operable to control the polarization of the reference optical pulse train such that the first optical pulse of the reference optical pulse train is equally power split into first and second replica optical pulses by the beam splitter of the interferometer, and
the beam splitter is configured to route the first replica optical pulse towards the first optical tap and to route the second replica optical pulse towards the second optical tap.

5. The QKD receiver of claim 1, wherein the at least one control signal is configured to cause the VOA to be configured in the second condition and is configured to enable the second optical detector and the third optical detector to detect final optical pulses a predetermined time after receipt of the trigger signal.

6. The QKD receiver of claim 5, wherein the predetermined time is a time delay between the reference optical pulse train and the signal optical pulse train.

7. A quantum key distribution (QKD) transmitter for an auto-compensating QKD system, the QKD transmitter comprising:
an input/output port configured to receive an initial optical pulse train;
a first optical beam splitter configured to power split the initial optical pulse train to form a first optical pulse train and a second optical pulse train;
a photodetector configured to detect optical pulses of the first optical pulse train and to output corresponding detection signals;
an optical storage line configured to receive the second optical pulse train;
a second optical beam splitter configured to receive the second optical pulse train output from the storage line and configured to power split the second optical pulse train to form a reference optical pulse train and a third optical pulse train;
optical routing apparatus configured to route the reference optical pulse train back to the input/output port;
an optical phase modulator configured to phase modulate optical pulses of the third optical pulse train;
a polarization rotation mirror arranged to reflect the third optical pulse train back through the optical phase modulator, and storage line, to form a signal optical pulse train; and
processing circuitry configured to cause the optical phase modulator to phase modulate optical pulses of the third optical pulse train in response to receiving a detection signal, wherein
the storage line is configured to introduce a time delay, t, between the reference optical pulse train and the signal optical pulse train, and
the input/output port is further configured to output the reference optical pulse train followed by the signal optical pulse train.

8. The QKD transmitter of any one of claim 7, wherein the optical storage line is thermally stabilized.

9. An auto-compensating quantum key distribution, (QKD) system comprising:
the QKD transmitter of claim 7; and
a QKD receiver, wherein
the QKD receiver is configured to send an initial optical pulse train to the QKD transmitter and to receive the reference optical pulse train followed by a signal optical pulse train from the QKD transmitter, and
the QKD transmitter is configured to receive the initial optical pulse train from the QKD receiver and to send the reference optical pulse train and the signal optical pulse train to the QKD receiver.

10. The system of claim 9, wherein
the initial optical pulse train has an initial optical pulse power,
the first beam splitter at the QKD transmitter is configured with a first splitting ratio for forming the second optical pulse train,
the second beam splitter at the QKD transmitter is configured with a second splitting ratio to form the third optical pulse train, and
the first splitting ratio and the second splitting ratio in combination cause optical pulses of the signal optical pulse train to comprise less than one photon per pulse on average.

11. The system of claim 9, wherein, at the QKD receiver, the predetermined time after receipt of the trigger signal is at least equal to the time delay, t, introduced by the storage line at the QKD transmitter.

12. A method of operating an auto-compensating quantum key distribution, (QKD) system comprising a QKD receiver and a QKD transmitter, the method comprising:
the QKD receiver sending an initial optical pulse train to the QKD transmitter;
the QKD transmitter splitting the initial optical pulse train to form a reference optical pulse train and a second optical pulse train;
the QKD transmitter phase modulating and time delaying the second optical pulse train relative to the reference optical pulse train, to form a signal optical pulse train;
the QKD transmitter sending the reference optical pulse train and the signal optical pulse train to the QKD receiver;
the QKD receiver tapping off a portion of the power of the reference optical pulse train to form trigger optical pulses;
the QKD receiver blocking the reference optical pulse train after formation of the trigger optical pulses and subsequently forwarding the signal optical pulse train to be detected; and
in response to detecting trigger optical pulses, enabling phase modulation of part of the signal optical pulse train and enabling detection of final optical pulses resulting from phase modulation and forwarding of the signal pulse train.
